(19) United States
(12) Patent Application Publication
(10) Pub. No.: US 2004/0153375 A1
(43) Pub. Date: Aug. 5, 2004

(54) System for trading and hedging product and brand sales

(76) Inventors: Alfred Kariuki Mukunya, West Chester, PA (US); Ajit Kumar, Calcutta (IN)

Correspondence Address: Daniel H. Shulman, Mayer, Brown, Rowe & Maw LLP, P.O. Box 2828, Chicago, IL, 60690-2828, US

(21) Appl. No.: 10/763,550

(22) Filed: Jan. 23, 2004

Related U.S. Application Data
(60) Provisional application No. 60/442,462, filed on Jan. 25, 2003.

(51) Int. Cl. G06F 17/60

(52) U.S. Cl. 705/26

(57) ABSTRACT

The present invention provides a system of trading and hedging product and brand sales. Financial institutions, investors, and corporations face sales risk when a product is to be brought to market. The invention involves identifying products and brands appropriate for trading, such as box office receipts on a particular movie. The invention provides for a process for pricing financial contracts based on parimutuel principles. The system also provides for secondary market trading of the financial contracts. The system facilitates trading through the Internet, through web and calculation servers, and databases storing required trader, product and contract information relevant for executing trades.

This application claims priority from U.S. Provisional Application No. 60/442,462, filed Jan. 25, 2003.

### BACKGROUND OF THE INVENTION

1. Field of the Invention

This invention relates generally to the field of trading, interactive and automated Web-based financial transaction applications, more specifically to a method, process and system of trading and hedging product and brand sales.

2. Background of the Invention

The Over the Counter derivatives markets has evolved rapidly trading in trillions of dollars annually, and the growth continues as market participants seek to hedge and trade risk in different markets and indices. These markets allow trading risk in interest rates, foreign exchange, equities, commodities and energy prices. More recently other traded risk includes gaseous emissions, weather and economic indices. None of these methods or processes have enabled participants to trade and price the risk in product and brand sales.

Using derivatives, corporations, financial institutions, governments, agencies and even farmers are able to manage their asset and liability portfolios, hedge their financial market risk, or hedge their exposure to price risk in their physical product.

A major risk faced by corporations that goes unhedged using derivatives is that of new brand or product sales. This invention provides a solution for an industry to mitigate or layoff risk due to the uncertainty of product sales. The best example that will be used continously in this disclosure is that of movie box office results. The performance of a single movie at the box office can affect the entire quarterly earnings of a production studio. Financiers, studios, investors in a company will have exposure to the performance of a movie and would need a vehicle to trade or hedge this risk.

Currently, if an investor wants exposure to a particular commodity, they can seek to take a position on a derivative product that trades based on the commodity itself. If one wants exposure to a particular brand or product, there is no direct way other than to invest in the product itself, or the company that produces the product. This invention allows a new market that enables investors to isolate and take exposure directly to a product or brand, without necessarily having to invest in the product, brand or company producing the product. Currently, for example, the variability and unknown nature of box office gross receipts are a risk that the industry can only address by syndicating out to the financial risk to investors in a particular movie. The performance risk at release of the product still remains to be borne by the investors. There is currently no commercially viable way in the capital markets to address this risk directly.

A corporation that is releasing a new brand or product is faced with a unique type of risk. In this discussion going forward, it is understood that when we refer to movie sales, it is a concept that is applicable to any new brand or product sales. Once a release date is set, there is an expected revenue performance on a product. There is risk on where the brand or product sales will come out.

A lot of risky outcomes have a platform where market traders can use derivatives to layoff or transfer their risk. Derivatives are traded on securities exchanges such as the Chicago Mercantile Exchange (CME), Chicago Board of Trade (CBOT), or traded through the Over the Counter (OTC) derivatives market. For the individual investor, online trading services for various instruments is available through trading firms such as E*Trade Securities, Inc., Charles Schwab & Co., Inc. and Fidelity Brokerage Services, Inc.. They permit trading of standard instruments in recognized markets.

Currently, there is no available process or method to hedge one's self against the risk of volatile sales, a situation which this invention seeks to remedy. Likewise, there currently is no platform on which one can take a position on expected sales.

Traditionally, when faced with a new market, practitioners create an index that industry participants would use to hedge and take a position on. In the regular securities markets, the participants have typically created indices with which to classify and hence define risk and return, which provides for instruments that would trade on or around these indices. When faced with new markets, the common first approach is to create a market index that borrowers, investors and speculators or any interested parties would take positions on. This approach works extremely well when the index defines a risk and return that is widely accepted, and faced by a lot of traders.

On the other hand, experience has shown you could end up with traders continuing to carry risk in a given market because there is no guarantee the index would perform like the underlying risk. To give an example in a large, but fragmented market such as the the Commercial Mortgage Backed Securities (CMBS) market, there have been several attempts to create a Mortgage index to hedge the risk borne by the investor or bond issuer. However, the different classes of bonds could behave very differently from the index, and leaving traders with the choice of picking from indices that may not track closely with their risk.

In further trying to determine the fundamental element of the risk in all successful derivatives markets, it boils down to having an actual asset, or an index that provides a store of value. If it is an index being hedged, the data point has to affect the issuer's cost of capital directly, for example the swap rate is used specifically to determine the cost of debt at any one time. Likewise, in another relatively large market, derivatives on stocks have the comfort of knowing they rest on a liquid, solid set of expectations of value, the stock price.

The S&P 500 index consists of stocks that trade on expectations of value. Investors whose risk is directly dependent on this index use derivatives on the S&P 500. Derivatives on these indices are used to hedge risks closely related to them. To take an example in the debt markets where a corporation has decided to issue a bond sometime in the future. A low credit bond issuer will purchase a payer swaption (option on swap rate) that has a payoff when the swap rate is high, when they feel the rate they will encounter in the future moves very close, or exactly like the swap rate. However, many investors would rather not hedge if the instruments available do not precisely match their risk.

The most successful instrument will be the one whose payoff fits the risk precisely. This is the reason why this system trades on movie or product sales expectations. Once a movie, brand or product release date is set, this invention recognizes two important occurrences:

(i) A corresponding market clearing sales expectation is established.

(ii) There is risk the revenue eventually recognized will be above or below the said sales expectations. This is the precise risk market participants will want to hedge. The invention entails (a) providing a platform for discovery of the actual specific brand and product revenue expectations, and (b) providing the means to trade around these expectations, using parimutuel principles. This would be applicable to products and brands that have an established time to release, with market participants that have a vested interest in the sales performance of the product.

Parimutuel principles are well known, and they consist of presenting traders payoffs based on the outcome of an event, and the total amount placed in a pool of funds. This is a well known method. Despite the fact that domestic box office gross for a single year is over 9 billion dollars, this method has never been applied before to trading box office receipts, or trading product and brand sales due to the unobviousness of such use of the application.

Currently, no system has attempted to address this risk facing any corporation or entity releasing a new product or brand, from movies to consumer goods. Regular derivative applications in the markets rely wholly on indices that require large numbers of participants for efficiency. This application needs only minimal number of members to operate efficiently. In addition, this application provides the means for ongoing, secondary trading of the contracts.

Computer trading systems are well known in the art. One such system is disclosed in U.S. Pat. No. 6,505,174, issued to Keiser et al., entitled “Computer-Implemented Securities Trading System with a Virtual Specialist Function”, and incorporated by reference herein. This patent currently in use by the Hollywood Stock Exchange (HSX, Inc.) at <www.hollywoodstockexchange.com> has created an exchange for trading stocks on movies using “Hollywood Dollars”, a virtual currency. HSX does not allow persons to trade, lay off their real exposure or price the contracts efficiently. In this prior art, there is no effective method or efficient algorithm used for pricing the contracts.

What is needed is a system and method that enables financial institutions, institutional investors, corporations and eligible participants to seamlessly price, execute and settle transactions to hedge or take positions on product sales expectations. The invention involves hedging the actual sales of a product, where the market participants take a position on the expectation of the actual product sales and providing a platform for trading and clearing these product sales expectations.

### SUMMARY OF THE INVENTION

Academics have studied box office receipts in attempting to predict box office revenues. Of the numerous models and tests available, all results show an inherent degree of uncertainty. Some models and techniques have had to fall back to using the box office receipts on the opening week as a guide, in order to achieve a better level of accuracy in attempting to predict box office results. However, the risk prior to the release of the movie is the most critical which is what this application seeks to address. This application provides market participants the ability to hedge and trade this risk.

Overall, this invention takes care of several key problems faced by prior attempts to create instruments to hedge in this market, including illiquidity and oligopolistic markets. Specifically the following are points unique to embodiments of this invention.

(i) It is believed that embodiments of this invention provide an entirely new risk management tool currently not available on the market today.

(ii) Embodiments of this invention provide a new way to define and hedge real risk faced by market participants in various industries. This risk of future revenue and sales is currently very hard to provide insurance for, if not impossible.

(iii) Initially, prime candidates for this application will be products with fixed deadlines of release, and a quick turnaround of sales. Movie and theater productions are typical examples. Other industries that would benefit from this would be consumer goods, when a new brand release is brought to market in a particular time.

(iv) To broaden the benefit of the application, the revenue recognition period can be defined over periods of days, such that we would have a curve of sales expectations against time, with corresponding hedging instruments for different time periods depending on market interest. For a particular brand, reset dates will established. On each date, expiring contracts will be settled or the contracts with larger time horizon can be reset to different states, based on the new information available. This will spread the risk of the stakeholders evenly thus bringing down the transaction costs. This will also act as added incentive for the participation of speculators and for other intrested parties with differing risk horizons, who could otherwise have been left out if the product offered a single point expiring option.

Preferably, embodiments of the invention include the platform to trade the contracts between the members, similar to a securities exchange ruled by price clearing based on demand and supply determined by market perception. This will lead to better pricing, more liquidity per contract, larger participation and opportunity for the contract holders to book profits as a secondary market for the instruments is provided.

As will be apparent in the detail, the manner this application prices options is akin to Cliquet Or Ratchet Options. The Ratchet option start out like a normal call option with a fixed strike price, but the strike is reset to be equal to the underlying asset price on a set dates that have been predetermined. When the strike price is reset, any positive value is locked in. If the underlying asset price at the next reset date is below the previous level, nothing happens except that strike price has been reset at a lower strike price which is equal to the underlying asset price.

With the ability to provide market established sales expectations over the life of a product, in other words, a curve of market data, the system can provide futures or swaps based on this said curve. In a preferred embodiment, the system will provide information on where the market expects a brand to sell at a given time. This would be the price clearing expectation, where the system would provide the ability for traders to place anonymous bids and asks on either side to face each other on a trade against the posted future sales expectation. For a futures contract, there would need to be daily mark-to-markets for margin, using new market pricing on sales expectations. This would be the same for forwards and swaps, but they would not have margin requirements. Mark to markets on these instruments would be driven by the ongoing sales expectations, or the manner in which the curve moves, on an intraday, daily, or weekly basis, or depending on how active a particular market is. Final settlement on the trades would happen at the predetermined point where the actual brand sales are recorded.

(v) Traders will include investors, companies with a vested interest in a particular brand, or speculators that want to take a position on the success or failure of a specific product release.

(vi) In defining expected sales over a life cycle of a product, the mature invention will allow hedging instruments that allow for fixing the expected sales of a specific product, akin to a swap that pays periodically over a period of time.

### SUMMARY OF THE INVENTION

The primary object of the invention is to provide a method and process for pricing, trading and hedging risk on new brand and product sales.

Another object of the invention is to provide a method, process and system for trading and hedging sales expectations, with final payoffs based on parimutuel principles on the final sales.

Another object of the invention is to provide a method, process and system, which for a nominal transaction fee, provides the ability for risk transfer among entities with differing risk profiles with respect to future sales of new brand and product releases.

A further object of the invention is to provide a system and method of above nature which when used for hedging or speculation on brand or product sales, will make possible the fungibility of the resulting contracts.

Yet another object of the invention is to provide a system and method that allows for risk transfer for the period defined as the brand or product release date or dates, and indefinitely afterward.

Still yet another object of the invention is to provide a system and method for the creation of instruments that would provide increased liquidity, pricing transparency, reduced credit risk, and other benefits attributable to parimutuel principles that will be brought to bear on the application.

Other objects and advantages of the present invention will become apparent from the following descriptions, wherein, by way of illustration and example, an embodiment of the present invention is disclosed.

In accordance with a preferred embodiment of the invention, there is disclosed a method, process and system of hedging product and brand sales, comprising the steps of identifying products and brands appropriate for trading, such as box office receipts on a particular movie. The invention provides for a process for pricing financial contracts based on parimutuel principles. The system also provides for secondary market trading of the financial contracts. The system facilitates trading through the Internet, through web and calculation servers, and databases storing required trader, product and contract information relevant for executing trades. A central exchange server receives bids and asks from members on contracts on specific products and period sales, two way terminals feed members information from the server, information regarding specific contracts with differing payoffs and maturities, while a calculation server provides the market's expected sales on the brand, as determined using parimutuel principles from members active trading inputs. The system therefore extracts information from the market on the curve (sales over time) of expected brand sales, and hence also provides ability to provide futures and swaps on specific brand and product sales. An embodiment of this method entails:

1. Predefined barriers and levels of payoffs viewed by members on their terminals,

2. Members input the amount they would pay to receive uniform amounts at predefined levels,

3. System calculates and shows expected sales given trader inputs,

4. Prior to maturity, system allows bids and offers on said contracts, and

5. At maturity or settlement, the system makes settlements on the contracts using parimutuel principles, where the traders receive payoff based on original total pool of investment less a nominal transaction fee.

6. Ability to provide exchange traded futures and Over the Counter swaps on specific brand and product sales, given market data from trading activity.

7. Provide market traders an exchange to buy and write regular options on futures and Over the Counter options on forwards for each product or brand.

### BRIEF DESCRIPTION OF THE DRAWINGS

The drawings constitute a part of this specification and include exemplary embodiments to the invention, which may be embodied in various forms. It is to be understood that in this instance various aspects of the invention are exaggerated, enlarged or left out to facilitate an understanding of the invention. This only describes one possible embodiment of carrying out the process and leaves out several others. In the figures, an entity named “CenterGroup” implements the invention.

FIG. 1 depicts a flowchart illustrating the general logic of an embodiment of the invention;

FIG. 2 depicts a flowchart illustrating the steps required for preparation of the contracts in an embodiment of the invention;

FIG. 3 depicts a flow diagram illustrating the steps required for acquiring participants for the process in an embodiment of the invention;

FIG. 4 depicts a flowchart illustrating the steps required for approvals and account processing for the participants in an embodiment of the invention;

FIG. 5 depicts a flowchart illustrating the steps required and information necessary for client data account processing in an embodiment of the invention;

FIG. 6 depicts a flowchart illustrating the steps required for trading account verification and reporting in an embodiment of the invention;

FIG. 7 depicts a flowchart illustrating the live trading at the point of interaction of the parimutuel pricing algorithm in an embodiment of the invention;

FIG. 8 depicts a flowchart illustrating the stages at settlements or disbursements in an embodiment of the invention;

FIG. 9 depicts a chart illustrating a sample of expected revenues and actual revenues of a product over time in an embodiment of the invention;

FIG. 10 depicts a block diagram of hardware and database configuration in an embodiment of the invention.

### DETAILED DESCRIPTION OF THE PREFERRED EMBODIMENTS

Descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The primary object of the invention is to provide a method for pricing trading and hedging instruments on new brand and product sales. A preferred embodiment of the invention can be referred to as BoxOfficeTRADE™, which is implemented as a method, process and system for pricing, trading and execution of contracts based on Box Office Results.

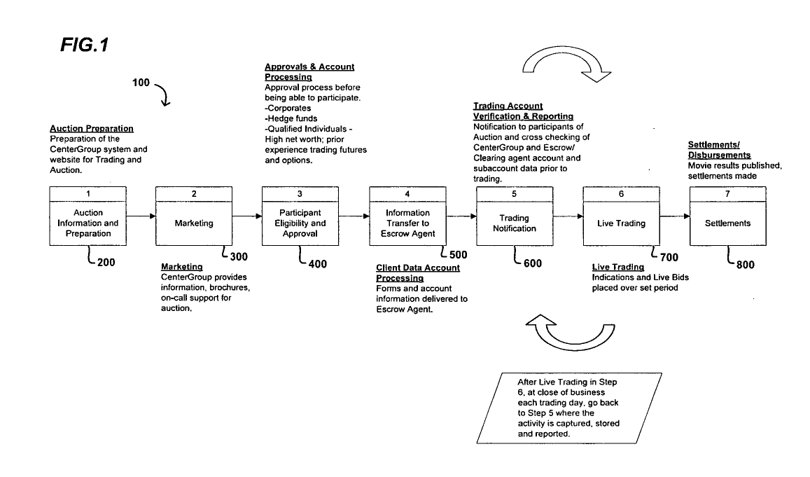

With reference to FIG. 1, the schematic overview of BoxOfficeTRADE is presented. This is an illustration of the architecture of one embodiement of this invention. Other embodiments will be apparent to and could be implemented by practitioners skilled in this art.

Preferred embodiments of BoxOfficeTRADE can be partitioned into 7 different stages:

a. Auction Preparation

b. Marketing

c. Approvals and Account Processing

d. Client Data Processing

e. Trading Account Verification and Reporting

f. Live Trading

g. Settlements and Disbursements

a. Auction Preparation

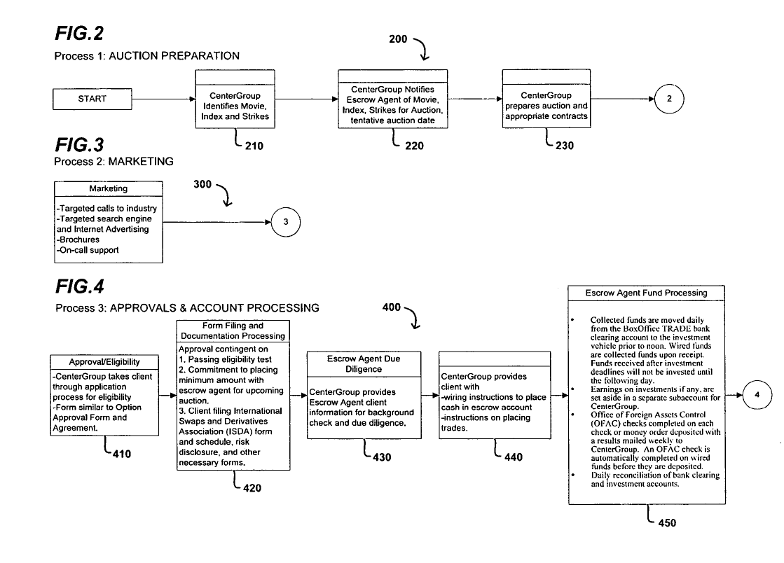

With reference to FIG. 2, the auction preparation stage 200 consists of, at step 210, identifying the movie for trading, identifying the datapoint around which positions will be placed, the strikes for the contracts, and other relevant contract data. This involves establishing all the range of outcomes possible for a movie, and presenting the market the complete range of strikes on which to bid. CenterGroup would conduct an informal poll on the range of strikes appropriate for trading. For example, for trading on opening week box office results for a movie with wide release nationwide, the strikes could be zero dollars to $10 million, greater than $10 million to $20 million and so on, in $10 million increments, to greater than $150 million. Notification 220 is made to the clearing agent, or escrow agent of the contract details, auction dates and other relevant information necessary for setting up the contracts to be traded. Preferably, CenterGroup also prepares the auction site with the appropriate contracts 230. This entails loading the system database with the movie title, strikes and contract definitions in preparation for trading.

b. Marketing

With reference to FIG. 3, a preferred embodiment includes a marketing stage 300 where the initial contact is made to the participants or traders who want to layoff or take on risk on the movies identified in the first stage. This stage also allows feedback for the market participants or traders in providing input of the manner of their risk exposure, and how they would want to trade it.

c. Approvals and Account Processing

FIG. 4 depicts a step for approvals and account processing 400 where application forms are filled in by potential participants 410. The forms are then taken through an approval process 420, including appropriate background checks, and other necessary due diligence. This includes satisfying eligibility criteria (such as credit checks). Signing onto the ISDA Master Agreement, and committing to an escrow agent. The escrow agent is notified 430 of this due diligence. Approval takes place here, and instructions are provided to the trader on where cash is to be received, as the trading account is made active 440. Escrow or clearing agent also perform their necessary daily tasks 450 to maintain the account.

d. Client Data Processing

FIG. 5 depicts the step of client data account processing 500. Detailed account information is provided 510 to the escrow or clearing agent where to wire funds to the trader at settlement. The detail 520 includes the movie name, transaction ID, trade date and all other relevant information particular to each trade between the traders. This is also where the escrow agent verifies 530 with the BoxOfficeTRADE managers of their approved trading accounts.

e. Trading Account Verification and Reporting

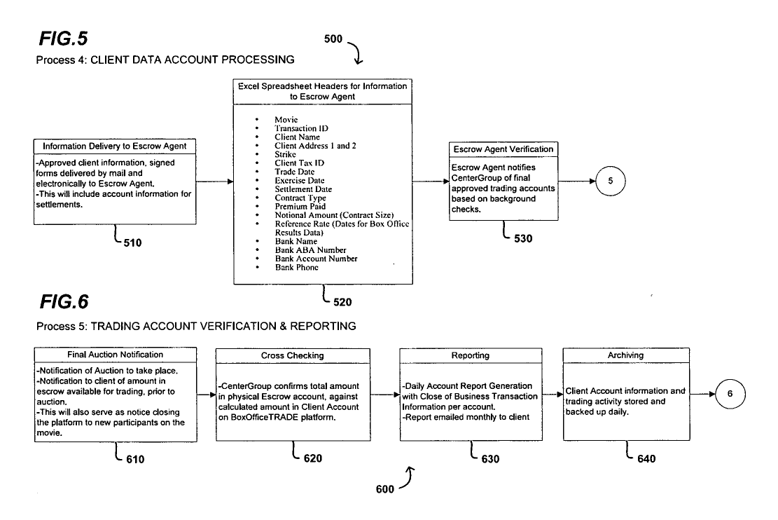

FIG. 6 depicts the stages immediately prior to an auction of the derivative contracts 600. Here, final auction notification is provided 610. This information will include a notification of the amount available for trading. At this point, the platform will be closed to new participants. At step 620, the System cross checks the amount in the client accounts against the amount in escrow. At step 630, which comes into play at the close of trading, daily reports are generated. Information is stored and backed up daily 640. Notification of when to receive bids, cross checking of amounts in escrow with clearing agent, report generation and archiving of the account information.

f. Live Trading

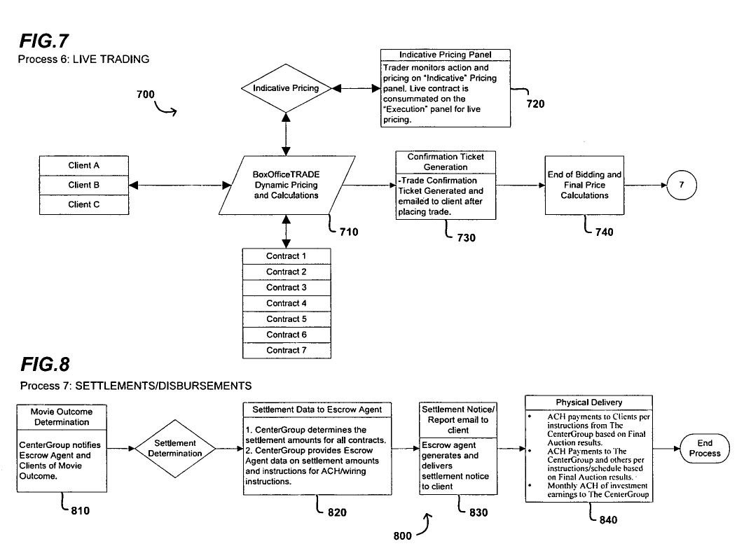

FIG. 7 depicts the stages during live trading 700 where the parimutuel pricing occurs, where the pricing is dynamically performed 710 based on bids and asks received from traders on the BoxOfficeTRADE system. CenterGroup may also provide the initial liquidity to price the contracts. Pricing and execution is performed 720, with generation of confirmation tickets emailed to the traders 730. At the end of the bidding and trading 740, the process can continue on to settlement, or back again to the trading notification stage depicted in FIG. 6, before another stage of trading.

At the end of the auction process, the prices and executed trades are checked for any discrepancies.

g. Settlements and Disbursements

FIG. 8 depicts the stage 800 where settlements and disbursements are made either to or from the traders, depending on the contracts they have entered into. Notification is made of what the movie outcome is to all participants in the relevant movie 810. Settlement data is delivered to the clearing house or escrow agent for all the contracts, with wiring instructions for each trader 820. Then a settlement notice is sent to the traders of the amounts to be delivered 830. Physical delivery is then made on the contracts to or from the traders to the clearing or escrow agent as per instructions by the BoxOfficeTRADE managers 840.

### EXAMPLE OF TRADING AND PRICING STRATEGY

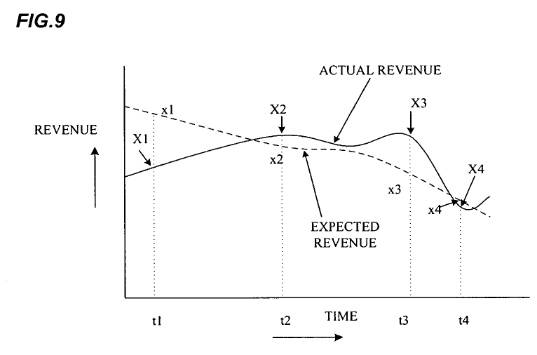

With reference to FIG. 9, a hypothetical movie has a scenario of. Xi, which denotes the actual revenue at time ti and xi's are the expected revenue from the point of view of a buyer of the contract, where i=1 to 4.

This process can offer four auctions separately for time t1, t2, t3 and t4. Traders with different time frames of risk can choose the respective auction to participate.

OR

Hedges can be offered for t1,t2,t3,t4, options maturing at (ti to tj) where i is not equal to j; i>j; i,j=1,2,3,4.

This can be coupled with alternatives such as being able to roll the hedges, for example, one acquires contract x1 but if this outcome does not occur, and the trader would like to hedge x2 and they are ready to pay some differential amount if x2 does not occur, therefore, one would be ready to roll over the same or less notional amount for the next event and so on.

OR

One could hedge more than one state regardless of what the outcome is at t1, t2, t3, t4.. One could also hedge using options on the difference in revenue expectations, the difference between x1 and X1.

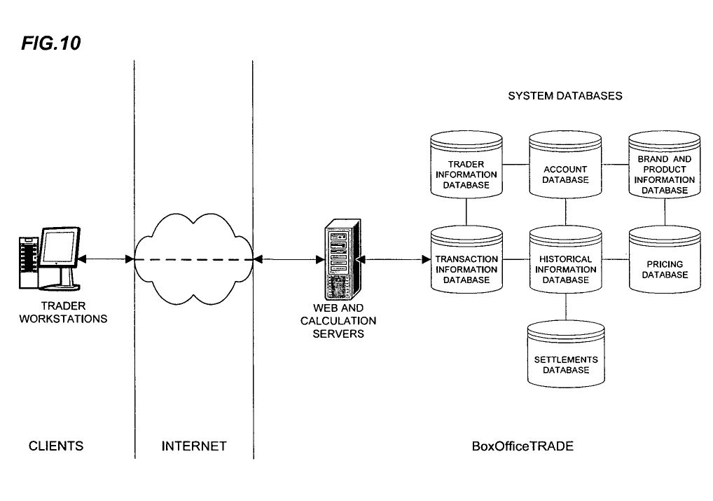

The 7 stages of BoxOfficeTRADE would be performed on a system architecture as depicted in FIG. 10, which shows traders accessing the system through the internet. The web servers would serve the pages and forms for each trader account, and display the trader information about their trades, account, pricing and other information contained in the databases. The calculation server would perform the algorithms necessary to calculate the prices of the contracts based on parimutuel payoff.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A system for trading product and brand sales among traders comprising:
a server to act as trading platform;
identifying a brand or product;
generating information regarding contracts available for trading and hedging on sales of the product or brand;
receiving information representative of trader eligibility for participating in creating a market in said contracts;
permitting trading of the contracts;
generating a trade ticket; and
facilitating payments on said contracts.

2. The system of claim 1 further comprising providing trader information to an escrow agent.

3. The system of claim 2 further comprising cross checking data with the escrow agent.

4. The system of claim 1, further comprising a server for generating, storing and presenting transaction information available for trading.

5. The system of claim 1, further comprising a server for disseminating information regarding trading contracts available.

6. The system of claim 1, further comprising a server, data forms and database for data input and storage.

7. The system of claim 2, further comprising facilitating data exchange between the escrow agent and the trader.

8. The system of claim 3, further comprising a server, database, SQL queries, forms and reports required to cross check data between parties involved in a trader account.

9. The system of claim 1, further comprising data forms and database for facilitating automated and live interaction between the trader and the server.

10. The system of claim 1, wherein a plurality of traders interact in dynamic fashion with the server.

11. The system of claim 1, comprising a plurality of contracts traded on the server.

12. The system of claim 1, comprising pricing of the contracts on the server.

13. The system of claim 12, wherein the server calculates and provides expected sales on the product or brand, as determined using parimutuel principles from active trading inputs.

14. The system of claim 12, wherein pricing is provided using parimutuel principles.

15. The system of claim 13, further comprising providing derivatives on the brand and product sales, based on market curves.

16. The system of claim 15, wherein the derivatives are futures.

17. The system of claim 15, wherein the derivatives are swaps.

18. The system of claim 15, wherein the derivatives are options.

19. The system of claim 1, wherein the server receives bids and asks from traders on contracts on the products or brands.

20. The system of claim 1, further comprising terminals connected to the server to exchange information regarding the contracts.

21. The system of claim 20, further comprising a means of having predefined barriers and levels of payoffs viewed by members on their terminals.

22. The system of claim 1, further comprising calculating and showing expected sales given trader inputs.

23. The system of claim 1, further comprising allowing bids and offers on said contracts prior to their maturity or settlement.

24. The system of claim 1, further comprising storing and disseminating information regarding executed trades.

25. The system of claim 1, further comprising facilitating settlement notices, settlements and disbursements specific to the contracts traded.

26. The system of claim 1, wherein on maturity or settlement date, traders receive disbursements based on an original total pool of investment less a nominal transaction fee.
